(19) United States
(12) Patent Application Publication
(10) Pub. No.: US 2011/0274000 A1
(43) Pub. Date: Nov. 10, 2011

(54) SYSTEM AND METHOD FOR DEVELOPING A WI-FI ACCESS POINT MAP USING SENSORS IN A WIRELESS MOBILE DEVICE

(75) Inventors: Peter King, San Mateo, CA (US); Xiang Sun, San Jose, CA (US)

(73) Assignee: Samsung Electronics Co., Ltd., Suwon-si (KR)

(21) Appl. No.: 12/776,031

(22) Filed: May 7, 2010

(51) Int. Cl. H04L 12/26; H04L 12/28

(52) U.S. Cl. 370/252; 370/255

(57) ABSTRACT

A wireless mobile device capable of developing a wireless fidelity (Wi-Fi) access point map. The mobile device comprises a Wi-Fi module and a processor. The Wi-Fi module is configured to communicate with a plurality of Wi-Fi access points and determine a signal strength from at least one of the Wi-Fi access points at each of a plurality of locations. The processor is configured to display a Wi-Fi access point map on a display of the mobile device, the map configured to associate the signal strength of the at least one Wi-Fi access point with each location, and direct a user of the mobile device to a location on the map, the location on the map having a stronger Wi-Fi signal that a current location of the mobile device.

### TECHNICAL FIELD OF THE INVENTION

The present application relates generally to wireless communication and, more specifically, to a system and method for developing a Wi-Fi access point map using sensors in one or more wireless mobile devices.

### BACKGROUND OF THE INVENTION

Today, many buildings and campuses include a number of wireless fidelity (Wi-Fi) access points. Such Wi-Fi access points allow wireless devices (especially mobile devices) access to one or more Wi-Fi networks. Through a Wi-Fi network, each wireless device may browse the Internet, exchange emails, hold voice conversations, or engage in a variety of other types of communication.

In many cases, a building may not have enough Wi-Fi access points to provide an acceptable wireless signal throughout the building. For example, wireless devices in some floors or wings of the building may experience a good Wi-Fi signal, while wireless devices in other floors or wings of the building may experience a poor Wi-Fi signal. Materials in walls, ceilings, and floors further affect a Wi-Fi signal.

When a user of a wireless device is in a location that does not have a good Wi-Fi signal, he or she may wish to move to a location associated with a stronger signal. However, the user may not be very familiar with the building, or with the Wi-Fi signal coverage throughout the building, in order to know where to move. Furthermore, even though the Wi-Fi module of prior art wireless devices can remember the SSID and credentials for a particular Wi-Fi access point, it typically cannot remember the overall Wi-Fi coverage of a building with multiple Wi-Fi points. Thus, the user cannot rely on a prior art wireless device to receive directions to move to a better coverage area.

### SUMMARY OF THE INVENTION

A wireless mobile device capable of developing a wireless fidelity (Wi-Fi) access point map is provided. The mobile device comprises a Wi-Fi module and a processor. The Wi-Fi module is configured to communicate with a plurality of Wi-Fi access points and determine a signal strength from at least one of the Wi-Fi access points at each of a plurality of locations. The processor is configured to display a Wi-Fi access point map on a display of the mobile device, the map configured to associate the signal strength of the at least one Wi-Fi access point with each location, and direct a user of the mobile device to a location on the map, the location on the map having a stronger Wi-Fi signal that a current location of the mobile device.

A method of using a Wi-Fi access point map is provided. The method comprises communicating with a plurality of Wi-Fi access points. The method also comprises determining a signal strength from at least one of the Wi-Fi access points at each of a plurality of locations. The method further comprises displaying a Wi-Fi access point map on a display of a wireless device, the map configured to associate the signal strength of the at least one WiFi access point with each location. The method still further comprises directing a user of the device to a location on the map, the location on the map having a stronger Wi-Fi signal that a current location of the device.

A wireless communication network is provided. The network comprises a plurality of Wi-Fi access points and an administrator configured for communication with the Wi-Fi access points and with a plurality of wireless mobile devices. The administrator is configured to receive from each of the mobile devices data comprising a plurality of locations and a signal strength of at least one of the Wi-Fi access points at each of the locations. The administrator is also configured to develop a Wi-Fi access point map, the map configured to associate the signal strength of the Wi-Fi access points with each location. The administrator is further configured to provide the Wi-Fi access point map to at least one of the mobile devices.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless mobile device according to one embodiment of the present disclosure;

FIG. 2 illustrates a Wi-Fi network configured for developing a Wi-Fi access point map, according to one embodiment of the present disclosure; and

FIG. 3 depicts another aspect of operation of the Wi-Fi network, according to one embodiment of the present disclosure.

### DETAILED DESCRIPTION OF THE INVENTION

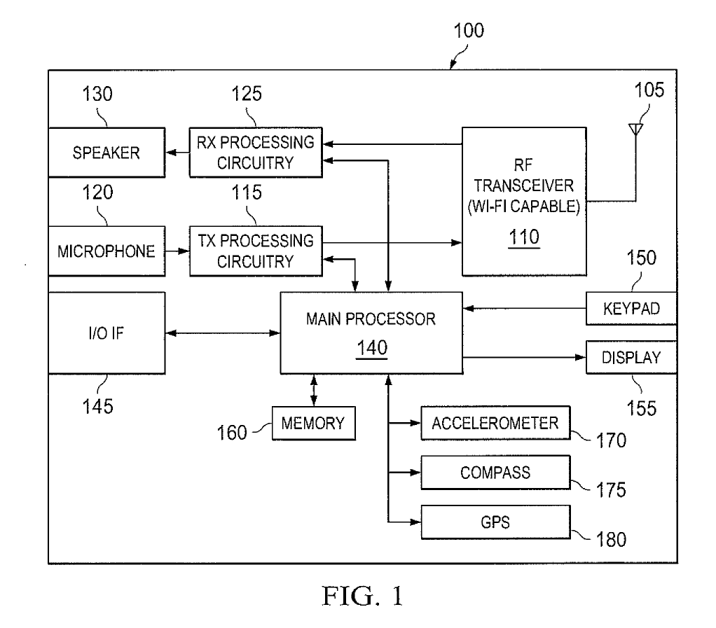

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present disclosure provides a system and method for developing a map of Wi-Fi access points in a location such as a building, using one or more wireless devices with a 3D magnetic compass, accelerometer sensor, and Wi-Fi module. The word “building” as used herein means any building, group of buildings, spaces around a building, campus, or similar area where Wi-Fi access points would be located.

FIG. 1 illustrates a wireless mobile device according to one embodiment of the present disclosure. Wireless mobile device 100 comprises antenna 105, radio frequency (RF) transceiver 110, transmit (TX) processing circuitry 115, microphone 120, and receive (RX) processing circuitry 125. Wireless mobile device 100 also comprises speaker 130, main processor 140, input/output (I/O) interface (IF) 145, keypad 150, display 155, and memory 160. Wireless mobile device 100 further comprises an accelerometer sensor 170, compass 175, and, optionally, a global positioning system (GPS) receiver 180.

Radio frequency (RF) transceiver 110 receives from antenna 105 an incoming RF signal transmitted by a base station of a wireless network, such as network 130. Radio frequency (RF) transceiver 110 down-converts the incoming RF signal to produce an intermediate frequency (IF) or a baseband signal. The IF or baseband signal is sent to receiver (RX) processing circuitry 125, which produces a processed baseband signal by filtering, digitizing the baseband or IF signal, additional filtering, if necessary, demodulation and/or decoding. Receiver (RX) processing circuitry 125 transmits the processed baseband signal to speaker 130 (i.e., voice data) or to main processor 140 for further processing (e.g., web browsing).

Transmitter (TX) processing circuitry 115 receives analog or digital voice data from microphone 120 or other outgoing baseband data (e.g., web data, e-mail, interactive video game data) from main processor 140. Transmitter (TX) processing circuitry 115 encodes, modulates, multiplexes, and/or digitizes the outgoing baseband data to produce a processed baseband or IF signal. Radio frequency (RF) transceiver 110 receives the outgoing processed baseband or IF signal from transmitter (TX) processing circuitry 115. Radio frequency (RF) transceiver 110 up-converts the baseband or IF signal to a radio frequency (RF) signal that is transmitted via antenna 105. In accordance with embodiments of the present disclosure, RF transceiver 110, processing circuitry 115 and 125, and/or main processor 140 comprise a Wi-Fi module configured for Wi-Fi communication.

In certain embodiments, main processor 140 is a microprocessor or microcontroller. Memory 160 is coupled to main processor 140. In certain embodiments, part of memory 160 comprises a random access memory (RAM) and another part of memory 160 comprises a non-volatile memory, such as Flash memory, which acts as a read-only memory (ROM).

Main processor 140 controls the overall operation of wireless device 100. In one such operation, main processor 140 controls the reception of forward channel signals and the transmission of reverse channel signals by radio frequency (RF) transceiver 110, receiver (RX) processing circuitry 125, and transmitter (TX) processing circuitry 115, in accordance with well-known principles. Main processor 140 executes software stored in memory 160 in order to control the overall operation of wireless device 100.

Main processor 140 is capable of executing other processes and programs resident in memory 160. Main processor 140 can move data into or out of memory 160, as required by an executing process. Main processor 140 is also coupled to I/O interface 145. I/O interface 145 provides mobile device 100 with the ability to connect to other devices such as laptop computers and handheld computers. I/O interface 145 is the communication path between these accessories and main controller 140.

Main processor 140 is also coupled to keypad 150 and display unit 155. The operator of mobile device 100 uses keypad 150 to enter data into mobile device 100. Display 155 may be a liquid crystal display capable of rendering text and/or graphics from web sites. In certain embodiments, display 155 may be a touch-sensitive screen and keypad 150 may be displayed on the touch-sensitive screen of display 155. Alternate embodiments may use other types of displays.

In accordance with embodiments of the present disclosure, main processor 140 is coupled to accelerometer sensor 170 and compass 175. Compass 175 may be, for example, a 3D magnetic compass. In certain embodiments, wireless device 100 also includes GPS receiver 180, which is coupled to main processor 140. Accelerometer 170, compass 175, and optional GPS receiver 180 enable wireless device 100 to track and provide location and orientation information, as described in greater detail herein.

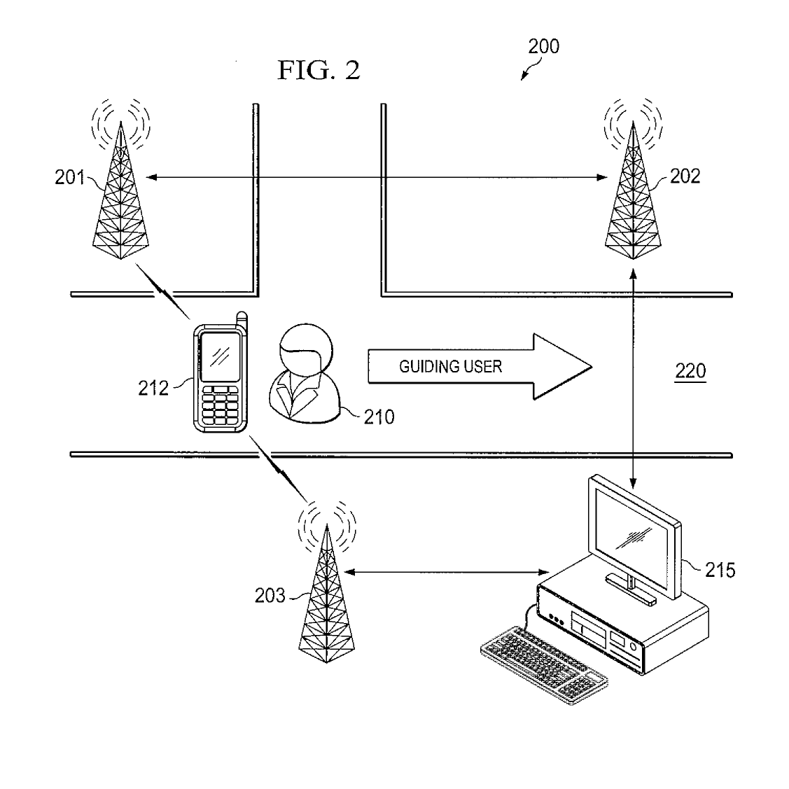

FIG. 2 illustrates a Wi-Fi network configured for developing a Wi-Fi access point map, according to one embodiment of the present disclosure. Wi-Fi network 200 comprises a number of Wi-Fi access points, represented by access points 201, 202, and 203. Wi-Fi network 200 also comprises user 210, mobile device 212, and administrator 215. Wi-Fi network 200 may be located substantially inside a building 220. Building 220 may include one or more stories, one or more interior rooms or areas, and one or more hallways or passageways.

Mobile device 212 may represent wireless mobile device 100 in FIG. 1. Mobile device 212 is in wireless communication with one or more access points 201-203. Access points 201-203 are in wireless and/or wired communication with each other and with administrator 215. User 210 uses wireless device 212 to engage in wireless communication via Wi-Fi network 200. In certain embodiments, administrator 215 may serve as network controller or network administrator for Wi-Fi network 200. In other embodiments, controller and administrator functions for Wi-Fi network 200 may be performed by one or more other devices (not shown). Likewise, administrator 215 may be an IT, network, or data administrator for a company, building 220, etc. Administrator 215 may be located inside building 220, or may be remote to building 220.

Mobile device 212 includes one or more algorithms for determining the location, orientation, and direction and speed of movement of device 212. The algorithms use empirical data which may be determined from reference experiments and preloaded into mobile device 212, or may be acquired over time during use of mobile device 212. In certain embodiments, the algorithms may be stored in memory 160 of mobile device 212. The algorithms may be used to carry out the operations of mobile device 212 described in greater detail below.

In one aspect of operation, mobile device 212 uses compass 175 and accelerometer sensor 170 to determine the location and orientation of device 212 within building 220. Using readings from accelerometer 170, along with a low pass filter associated with the accelerometer 170, mobile device 212 calculates the direction of gravity. Mobile device 212 uses digital compass 175 in conjunction with accelerometer 170 to detect the direction that device 212 is facing. As mobile device 212 moves, it uses compass 175 and accelerometer sensor 170 to detect changes in location, orientation, and direction of movement, as well as speed of movement. In certain embodiments, the location, orientation, and direction and speed of movement are determined with respect to a known point or landmark, e.g., an entrance to building 220. Thus, mobile device 212 is aware of its movement around building 220. For example, mobile device may sense that it is moving up a stair well, down a hallway, or in any other direction.

As described earlier, mobile device 212 may optionally include GPS receiver 180. A GPS receiver typically does not operate well within a building. Thus, GPS receiver 180 may not be used to track wireless device 212 while it is in building 220. However, some buildings, particularly large ones, may have multiple entrances from the outside. In such a case, GPS receiver 180 may be used to determine which entrance device 212 uses to enter building 220. Then once inside building 220, device 212's location can be determined from its movement away from that entrance.

As mobile device 212 moves within building 220, the Wi-Fi RSSI (signal strength) associated with nearby Wi-Fi access points changes. Since each Wi-Fi access point has a unique BSSID or MAC address to identify itself, mobile device 212 can detect the handoff between access points and estimate an approximate distance and direction to each nearby access point. The Wi-Fi environmental data is cached on device 212. Later, device 212 may use the Wi-Fi environmental data to prompt user 210 to move to a different location if the Wi-Fi coverage is poor at a particular location.

In certain embodiments, mobile device 212 includes a simple Wi-Fi locator user interface. The simple user interface may provide an arrow or similar indicator on display 155 that points in a direction where better Wi-Fi coverage is located. In other embodiments, mobile device 212 includes a more detailed Wi-Fi locator user interface. The more detailed user interface may display an actual map or simulation of building 220 with indicators pinpointing the location of better coverage. The user interface may include verbal or textual directions guiding a user to an improved Wi-Fi signal. For example, empirical data obtained from the accelerometer and compass could be used to provide very detailed step-by-step directions for navigating the building, such as “move 10 meters east” or “walk 10 steps down the hallway and turn right, then take 3 more steps” or “take the elevator to the third floor and go 20 feet west from the elevator.”

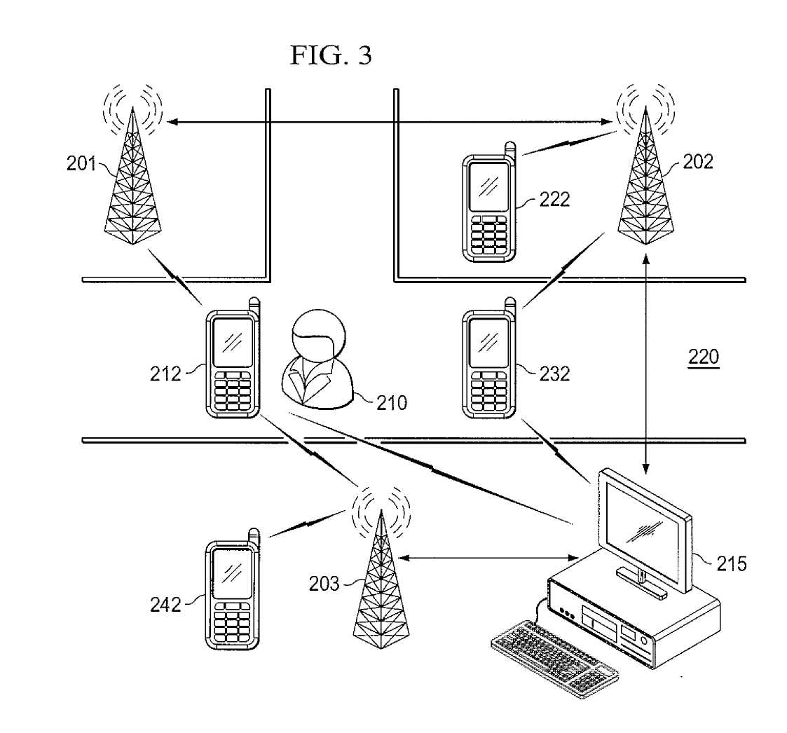

FIG. 3 depicts another aspect of operation of the Wi-Fi network, according to one embodiment of the present disclosure. In this embodiment, administrator 215 is used to obtain information related to Wi-Fi coverage, and provide the information to mobile device 212. In one embodiment, administrative personnel may walk (or otherwise move) one or more smart wireless devices (e.g., device 212) around building 220 to survey Wi-Fi signal strength readings throughout building 220. This information is then sent to administrator 215 for processing and storage. Alternatively or additionally, Wi-Fi coverage information is collected from a variety of devices (e.g., devices 212, 222, 232, 242) over time, with each device reporting coverage information to administrator 215 as it is moves to a new location or encounters a change in Wi-Fi signal strength. This method is particularly useful in a building with many wireless devices that move around the building.

For example, assume building 220 is populated with a number of wireless devices (e.g., devices 222, 232, 242) similar to device 212. As each wireless device moves about building 220, the device provides an indication of Wi-Fi signal strength to administrator 215, which collects the aggregate data. For example, as device 212 provides signal strength information to administrator 215, administrator 215 identifies the location of device 212 using RSSI readings. Alternatively, device 212 may provide its location information based on data from accelerometer 170 and compass 175. As Wi-Fi signal strength data is collected over time from multiple devices in multiple locations, each location is associated with a particular signal strength. If multiple devices report a signal strength for a single location, administrator 215 may calculate a representative strength for the location, such as by averaging the various reported values. Thus, administrator 215 will develop a map of signal strengths over time. Later, administrator 215 may push the map down to device 212. In certain embodiments, the map is customized based on the location of device 212.

Signal strength information may be constantly received and processed by administrator 215. The information is then shared with wireless device 212 according to a variety of time tables. In certain embodiments, signal strength information is requested by device 212 continuously, periodically according to a predetermined time schedule, or only when prompted by user 210. In other embodiments, signal strength information is pushed from administrator 215 to device 212 automatically, either continuously or periodically according to a predetermined time schedule.

As described earlier, wireless device 212 may develop its own map of signal strengths as it moves about building 220. In this case, device 212 would not need to get Wi-Fi signal information from administrator 215. However, building map information from administrator 215 could be sent to device 212 to augment the Wi-Fi signal map information generated by device 212.

Embodiments of the present disclosure may have additional applications. For example, the disclosed system may be used by IT administrators to survey Wi-Fi environmental parameters in a location (e.g., a building) and optimize the placement of the access points around the location. The disclosed system may also be used to trace a phone within an enterprise's premise.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication network, a wireless mobile device capable of developing a wireless fidelity (Wi-Fi) access point map, the mobile device comprising:
a Wi-Fi module configured to:
communicate with a plurality of Wi-Fi access points; and
determine a signal strength from at least one of the Wi-Fi access points at each of a plurality of locations; and
a processor configured to:
display a Wi-Fi access point map on a display of the mobile device, the map configured to associate the signal strength of the at least one Wi-Fi access point with each location; and
direct a user of the mobile device to a location on the map, the location on the map having a stronger Wi-Fi signal that a current location of the mobile device.

2. The wireless mobile device of claim 1, wherein the processor is further configured to communicate to an administrator the signal strength from the at least one access point at each location.

3. The wireless mobile device of claim 2, wherein the Wi-Fi module is further configured to receive the map from the administrator.

4. The wireless mobile device of claim 1, wherein the processor is further configured to develop the map.

5. The wireless mobile device of claim 1, the wireless mobile device further comprising:
a compass; and
an accelerometer;
wherein the processor is further configured to determine the current location of the mobile device using data received from at least one of the compass and the accelerometer.

6. The wireless mobile device of claim 1, wherein the current location of the mobile device is determined with respect to a known point in a building.

7. The wireless mobile device of claim 6, the wireless mobile device further comprising a GPS receiver, wherein the known point in the building is determined using the GPS receiver.

8. For use in a wireless communication network, a method of using a wireless fidelity (Wi-Fi) access point map, the method comprising the steps of:
communicating with a plurality of Wi-Fi access points;
determining a signal strength from at least one of the Wi-Fi access points at each of a plurality of locations;
displaying a Wi-Fi access point map on a display of a wireless device, the map configured to associate the signal strength of the at least one WiFi access point with each location; and
directing a user of the device to a location on the map, the location on the map having a stronger Wi-Fi signal that a current location of the device.

9. The method of claim 8, further comprising the step of:
communicating to an administrator the signal strength from the at least one access point at each location.

10. The method of claim 9, further comprising the step of:
receiving the map from the administrator.

11. The method of claim 8, further comprising the step of:
creating the map at a processor in the wireless device.

12. The method of claim 8, further comprising the step of:
determining the current location of the wireless device.

13. The method of claim 12, wherein determining the current location of the wireless device comprises receiving data from at least one of a compass and an accelerometer.

14. The method of claim 12, wherein the current location is determined with respect to a known point in a building.

15. The method of claim 14, wherein the known point in the building is determined using a GPS receiver.

16. The method of claim 8, wherein directing the user of the device comprises step-by-step directions for navigating a building.

17. The method of claim 16, wherein the step-by-step directions are spoken to the user.

18. A wireless communication network, the network comprising:
a plurality of wireless fidelity (Wi-Fi) access points; and
an administrator configured for communication with the Wi-Fi access points and with a plurality of wireless mobile devices, the administrator configured to:
receive from each of the mobile devices data comprising a plurality of locations and a signal strength of at least one of the Wi-Fi access points at each of the locations;
develop a Wi-Fi access point map, the map configured to associate the signal strength of the Wi-Fi access points with each location; and
provide the Wi-Fi access point map to at least one of the mobile devices.

19. The network of claim 18, wherein the administrator is configured to collect the data from each of the mobile devices over a period of time as each mobile device moves among the plurality of locations.

20. The network as set forth in claim 18, wherein the administrator is configured to calculate a representative signal strength for a first location based on signal strength data for the first location from multiple mobile devices.
